(19) United States
(12) Patent Application Publication
(10) Pub. No.: US 2005/0079992 A1
(43) Pub. Date: Apr. 14, 2005

(54) Cleaning composition and methods

(75) Inventor: Kim R. Smith, Woodbury, MN (US)

Correspondence Address: Merchant & Gould P.C., P.O. Box 2903, Minneapolis, MN, 55402-0903, US

(73) Assignee: Ecolab Inc.

(21) Appl. No.: 10/683,905

(22) Filed: Oct. 10, 2003

(51) Int. Cl. C11D 1/00

(52) U.S. Cl. 510/506

(57) ABSTRACT

The present invention relates to methods and compositions for cleaning surfaces including carpet or upholstery. The compositions include degreasing penetrant, anionic surfactant, and optionally, an amphoteric surfactant to provide foaming characteristics. The methods of cleaning a surface, such as carpet or upholstery, include applying to the surface such a composition or a use solution of one of these compositions.

### FIELD

The present invention relates to compositions and methods for cleaning carpet, upholstery, and other surfaces. The liquid composition includes a degreasing penetrant, a nonionic surfactant, and preferably an amphoteric surfactant. The methods of cleaning carpet or other surfaces include applying to the carpet or other surface a liquid composition, which can be a foam.

### BACKGROUND

Carpet and upholstery cleaning represent a substantial service industry in the United States and other industrialized nations. Upward of several billion dollars per year are spent on carpet and upholstery cleaning services in the United States alone. Conventional cleaning or sanitizing methods or compositions can remove substantial amounts of dirt, stains, and microbial contamination. These conventional methods and compositions, however, still leave behind noticeable stains and ground in dirt, which often must be removed by an additional pre-spotting step. Various stains are especially difficult to remove, even with the additional pre-spotting step. One such difficult-to-remove stain is red colored “Kool-Aid” drink.

Attempts have been made to remove stains such as red colored “Kool-Aid” with products that include reducing bleaches; sodium sulfite is a typical component of such products. The process for removing a stain with these products includes applying the reducing bleach product to the surface to be cleaned, such as a carpet, and then applying heat, typically from a conventional laundry iron, to the carpet. Care must be taken that the carpet, or other surface being cleaned, is not damaged by the applied heat. This complicated and tedious process, however, may not thoroughly remove the stain.

There remains a need for improved methods and compositions for accomplishing cleaning and/or removing spots from carpets, upholstery, and other surfaces.

### SUMMARY OF THE DISCLOSURE

The present invention relates to compositions and methods for cleaning carpets, upholstery, and other surfaces. The compositions, according to the disclosure, include a degreasing penetrant, a nonionic surfactant, and preferably, an amphoteric surfactant, to provide foam or foaming characteristics to the composition. The foam can be created by a mechanical apparatus, such as a screen, through which the composition passes prior to application on the surface to be cleaned. In one embodiment, the composition is aqueous and includes a builder, an alkalinity source, a nonionic surfactant, a degreasing penetrant, an anionic hydrotrope, and preferably an amphoteric surfactant.

The degreasing penetrant within the composition provides enhanced wetting of the surface to be cleaned and allows enhanced soil penetration. A preferred degreasing penetrant is ethylene oxide-propylene oxide co-polymer (also referred to as EO/PO co-polymer or merely EO/PO).

The nonionic surfactant provides soil removal and cleaning power. The nonionic surfactant can also provide emulsification, and other desirable properties for the cleaning composition. A preferred nonionic surfactant is an ethoxylate.

The builder can provide cleaning, chelating, antimicrobial activity, water softening, active oxygen stabilization, and other desirable properties for the cleaning composition. Preferred compositions include an aminocarboxylate (e.g., EDTA) as builder.

In one embodiment, the composition includes about 1-20% builder, 1-20% alkalinity source, 0.01-20% nonionic surfactant, 0.01-10% degreasing penetrant, 1-20% anionic hydrotrope, 1-20% amphoteric surfactant, and 30-99% water. In another embodiment, the composition can include about 2-10% builder, 2-10% alkalinity source, 0.1-10% nonionic surfactant, 0.02-5% degreasing penetrant, 2-10% anionic hydrotrope, 2-10% amphoteric surfactant, and 50-80% water.

In yet another embodiment, the composition includes about 1-20% builder, 1-20% alkalinity source, 0.01-20% nonionic surfactant, 0.01-10% EO/PO copolymer, 1-20% anionic hydrotrope, 1-20% amphoteric surfactant, and 30-99% water. In still another embodiment, the composition can include about 2-10% builder, 2-10% alkalinity source, 0.1-10% nonionic surfactant, 0.02-5% EO/PO copolymer, 2-10% anionic hydrotrope, 2-10% amphoteric surfactant, and 50-80% water.

The cleaning composition, when discussed herein, is generally referred to as a “concentrate”. Generally, even if not specifically indicated, the composition is in a concentrate form. For use, the composition concentrate is diluted from the concentrate, typically with water, to form a “use composition”.

The composition can be used for overall, general cleaning of a surface (such as carpet) or can be used as a spot treater or precleaner.

The methods of cleaning the surface, in accordance with this disclosure, include applying to the surface a liquid composition. In a preferred embodiment, the liquid composition is applied as a foam to the surface. In one embodiment, the method can include mixing a composition concentrate with a solvent (preferably water) to form a use composition, and applying the use composition to the surface to be cleaned. In another embodiment, the method can include mixing a composition concentrate with a solvent (preferably water) to form a use composition, and applying the use composition as a foam to the surface to be cleaned. The method can also include removing at least part of the use composition from the carpet.

In one particular embodiment, the composition comprises about 0.01 to about 10 wt-% penetrant, and about 0.01 to about 20 wt-% nonionic surfactant. The penetrant can be EO/PO copolymer. In another embodiment, the composition comprises about 0.02 to about 5 wt-% EO/PO copolymer, about 0.1 to about 10 wt-% nonionic surfactant, and about 2 to about 10 wt-% amphoteric surfactant. In still another embodiment, the composition comprises about 0.02 to about 5 wt-% EO/PO copolymer, about 0.1 to about 10 wt-% nonionic surfactant, about 2 to about 10 wt-% amphoteric surfactant, about 2 to about 10 wt-% builder, about 2 to about 10 wt-% alkalinity source, and about 2 to about 10 wt-% anionic hydrotrope.

Additional details regarding the methods and the compositions are provided below.

### BRIEF DESCRIPTION OF THE FIGURES

FIG. 1 is a digital photograph of a carpet before cleaning with a composition according to and by a method of the present invention.

FIG. 2 is a digital photograph of the carpet of FIG. 1 after cleaning with a conventional, commercial carpet cleaning detergent.

FIG. 3 is a digital photograph of the carpet of FIG. 1 after cleaning with a composition according to and by a method of the present invention.

### DETAILED DESCRIPTION OF THE INVENTION

The present invention is directed to a chemical composition and use of that composition to clean carpets, upholstery, and other various items and surfaces. Throughout this description, the described composition is generally a “concentrate”. By use of the term “concentrate”, what is intended is a solution or mixture of ingredients present at a level stronger than needed to obtain sufficient cleaning according to the method of the invention. For cleaning use, the composition concentrate is diluted from the concentrate, with a solvent (typically water), to form a “use composition”.

As used herein, “weight percent”, “wt-%”, “percent by weight”, “% by weight”, and the like are synonyms that refer to the concentration of a substance as the weight of that substance divided by the total weight of the composition and multiplied by 100. It is understood that, as used here, “percent”, “%”, and the like are intended to be synonymous with “weight percent”, “wt-%”, etc.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Although the phrase “carpet cleaning”, “carpet and upholstery cleaning”, and the like are used herein, it should be understood that what is intended by such use is cleaning of any surface including carpet, rugs, upholstery, curtains, countertops, backsplashes, cabinets, and the like.

The Cleaning Composition

In its most basic aspect, the present cleaning composition includes a mixture of a degreasing penetrant and a nonionic surfactant. An amphoteric surfactant can be added, for example, to provide foaming properties, when desired. Typically, the cleaning composition has a mixture of a degreasing penetrant, a nonionic surfactant, a builder, an alkalinity source, an anionic hydrotrope, and, preferably, an amphoteric surfactant.

The present composition lightens stains, preferably removes stains, from carpet or other surfaces by both bleaching the stain and also removing the soil that makes up the stain. The present composition preferably removes stains and soil without pre-spraying and without pre-spotting of these stains or areas with this or another cleaning composition. Red colored “Kool-Aid” drink is a stain for which removal the composition is particularly suited. These are but a selection of the numerous advantages of the present compositions for cleaning.

Some examples of cleaning compositions (as cleaning concentrates) according to or as used in the methods of the present invention can be found in Table 1, in which the values are given in wt-% of the ingredients in reference to the total composition weight.

TABLE 1
Compositions for Cleaning Composition Concentrates

| | Typical wt- % | Preferred wt- % | More Preferred |
|---|---|---|---|
| Component | Range | Range | wt- % Range |
| Water | 30-99 | 50-80 | 55-70 |
| Builder | 1-20 | 2-10 | 2-5 |
| Alkalinity source | 1-20 | 2-10 | 2-5 |
| Nonionic surfactant | 0.01-20 | 0.1-10 | 0.1-5 |
| EO/PO copolymer | 0.01-10 | 0.02-5 | 0.02-1 |
| Anionic hydrotrope | 1-20 | 2-10 | 2-5 |
| Amphoteric | 1-20 | 2-10 | 2-5 |
| surfactant | | | |

Degreasing Penetrant

The composition includes a degreasing penetrant. A variety of degreasing penetrants, or mixtures of degreasing penetrants, can be employed. Suitable degreasing penetrants are commercially available from a number of sources.

The penetrant is preferably an ethylene oxide-propylene oxide co-polymer (also referred to as EO/PO co-polymer or merely EO/PO). The EO/PO block or hetreric block copolymer preferably has a cloud point of at least 27° C. and is low foaming.

Degreasers having a mixture of alcohol ethoxylate and EO/PO copolymer are known; see, for example, U.S. Pat. Nos. 6,440,919; 6,133,218; 5,977,048; 5,965,509; 5,958,860; and 5,958,859, the disclosures of which are incorporated herein by reference.

Examples of suitable, commercially available penetrants include those available from BASF under the tradenames PLURONIC™ and TETRONIC™. Those penetrants known as “reverse” copolymers are also suitable. One preferred material, which includes EO/PO block copolymer therein, for use in the cleaning composition is one such as exemplified by BASF's “PLURONIC N3”.

The level of the penetrant in the composition should be such that it does not interfere substantially with any foamability of the composition, yet allows for enhanced wetting of carpet fibers or other material fiber and allows enhanced soil penetration.

Usually, cleaning compositions according to the present invention will contain no more than about 20 wt-% penetrant and typically no more than about 10 wt-%. One embodiment includes about 0.01-10 wt-%, preferably about 0.02-5 wt-%, and most preferably 0.02 to about 1 wt-% penetrant. Use compositions of these concentrates preferably contain no more than about 5 wt-% penetrant, more preferably 0.01 to about 2 wt-% surfactant, and most preferably 0.02 to about 1 wt-%.

Nonionic Surfactant

The cleaning composition also includes a nonionic surfactant. The nonionic surfactant advantageously provides soil removal and cleaning power. The nonionic surfactant can also provide emulsification, and other desirable properties for a cleaning composition. A variety of nonionic surfactants, or mixtures of nonionic surfactants, can be employed. Suitable nonionic surfactants are commercially available from a number of sources.

Nonionic surfactants particularly useful in the present cleaning compositions include alkyl-, aryl-, and aralkyl-, alkoxylates, alkylpolyglycosides and their derivatives, amines and their derivatives, and amides and their derivatives.

Additional useful nonionic surfactants include those having a polyalkylene oxide polymer as a portion of the surfactant molecule. Such nonionic surfactants include, for example, chlorine-, benzyl-, methyl-, ethyl-, propyl-, butyl- and other like alkyl-capped polyethylene and/or polypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and ethoxylated amines and ether amines and other like nonionic compounds. Silicone surfactants can also be used.

Additional suitable nonionic surfactants having a polyalkylene oxide polymer portion include nonionic surfactants of C6-C24 alcohol ethoxylates (preferably C6-C14 alcohol ethoxylates) having 1 to about 20 ethylene oxide groups (preferably about 9 to about 20 ethylene oxide groups); C6-C24 alkylphenol ethoxylates (preferably C8-C10 alkylphenol ethoxylates) having 1 to about 100 ethylene oxide groups (preferably about 12 to about 20 ethylene oxide groups); C6-C24 alkylpolyglycosides (preferably C6-C20 alkylpolyglycosides) having 1 to about 20 glycoside groups (preferably about 9 to about 20 glycoside groups); C6-C24 fatty acid ester ethoxylates, propoxylates or glycerides; and C4-C24 mono or dialkanolamides.

Specific alcohol alkoxylates suitable for use in the present composition include alcohol ethoxylate propoxylates, alcohol propoxylates, alcohol propoxylate ethoxylate propoxylates, alcohol ethoxylate butoxylates, and the like; nonylphenol ethoxylate, polyoxyethylene glycol ethers and the like; and polyalkylene oxide block copolymers, which can include an ethylene oxide/propylene oxide block copolymer (EO/PO), such as available under the PLURONIC trademark.

Preferred nonionic surfactants include low foaming nonionic surfactants, although, higher foaming nonionic surfactants can be employed in the compositions and methods of the present invention. Examples of preferred, low foaming, nonionic surfactants include secondary ethoxylates, such as those sold under the trade name TERGITOL, such as TERGITOL 15-S-7 (Union Carbide), TERGITOL 15-S-3, TERGITOL 15-S-9 and the like. Other preferred classes of low foaming nonionic surfactant include alkyl or benzyl-capped polyoxyalkylene derivatives and polyoxyethylene/polyoxypropylene copolymers. A useful nonionic surfactant for use as a defoamer is nonylphenol having an average of 12 moles of ethylene oxide condensed thereon, it being end capped with a hydrophobic portion comprising an average of 30 moles of propylene oxide. Silicon-containing defoamers are also well-known and can be employed in the compositions and methods of the present invention.

Usually, cleaning compositions according to the present invention will contain no more than about 30 wt-% nonionic surfactant and typically no more than about 20 wt-%. One embodiment includes about 0.01-20 wt-%, preferably about 0.1-10 wt-%, and most preferably 0.1 to about 5 wt-% nonionic surfactant. Use compositions of these concentrates preferably contain no more than about 10 wt-% nonionic surfactant, more preferably 0.1 to about 5 wt-% surfactant, and most preferably 0.1 to about 2 wt-%.

Amphoteric Surfactant

The composition preferably includes an amphoteric surfactant to provide foam or foaming characteristics to the composition. A variety of amphoteric surfactants, or mixtures of amphoteric surfactants, can be employed. Suitable amphoteric surfactants are commercially available from a number of sources.

Preferred amphoteric surfactants include amine oxide compounds having the formula: 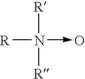
where R, R′, R″, and R′″ are each a C₁-C₂₄ alkyl, aryl or aralkyl group that can optionally contain one or more P, O, S or N heteroatoms.

Another class of preferred amphoteric surfactants includes betaine compounds having the formula: 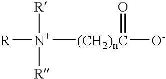
where R, R′, R″ and R′″ are each a C₁-C₂₄ alkyl, aryl or aralkyl group that can optionally contain one or more P, O, S or N heteroatoms, and n is about 1 to about 10. One preferred betaine compound for use the cleaning composition is cocoamidopropylbetaine.

Other preferred surfactants include food grade surfactants, linear alkylbenzene sulfonic acids and their salts.

Usually, cleaning compositions according to the present invention will contain no more than about 20 wt-% amphoteric surfactant and typically no more than about 10 wt-%. One embodiment includes about 1-20 wt-%, preferably about 2-10 wt-%, and most preferably 2 to about 5 wt-% amphoteric surfactant. Use compositions of these concentrates preferably contain no more than about 10 wt-% amphoteric surfactant, more preferably 0.1 to about 5 wt-% surfactant, and most preferably 0.1 to about 2 wt-%.

Builder

Builders can be, and preferably are, included in the cleaning compositions of the present invention for purposes including assisting in controlling mineral hardness. Builders include chelating agents (chelators), sequestering agents (sequestrants), detergent builders, and the like. Inorganic builders and organic builders, or combinations of both, can be used. The builder can also function as a threshold agent when included in an effective amount. The builder preferably functions to stabilize the compositions. Preferably, the level of chelating agent builder is sufficient to prevent precipitation in hard water. The level of builder can vary widely, however, the preferred use level should be such to allow dilution of the compositions with 20 grain water hardness to the use concentration without formation of undesirable precipitate.

Builders generally useful in the present compositions include phosphonic acid and phosphonates, phosphates, aminocarboxylates and their derivatives, pyrophosphates, polyphosphates, ethylenediamene and ethylenetriamene derivatives, hydroxyacids, and mono-, di-, and tri-carboxylates and their corresponding acids. Other generally useful builders includes aluminosilicates, nitroloacetates and their derivatives, and mixtures thereof.

Preferred builders are water soluble and do not contain phosphorus. Aminocarboxylates are particularly preferred builders, including salts of ethylenediaminetetraacetic acid (EDTA), hydroxyethylenediaminetetraacetic acid (HEDTA), and diethylenetriaminepentaacetic acid. Various suitable builders are briefly discussed below.

Usually, a cleaning composition includes no more than about 50 wt-% builder, typically no more than about 30 wt-%. The composition usually includes about 0.5-50 wt-%, preferably about 1-20 wt-%, preferably about 2-10 wt-% of one or more builders, e.g., one or more builders, chelating agents (chelators), or sequestering agents (sequestrants). In certain embodiments, the composition concentrate includes about 2-5 wt- % builder. Use compositions of these concentrates preferably contain no more than about 10 wt-% builder, more preferably 0.1 to about 5 wt-% builder, and most preferably 0.1 to about 2 wt-%.

Aminocarboxylates

Aminocarboxylates for use as a builder in the present compositions include any that are suitable for use with the nonionic surfactant and penetrant. Aminocarboxylate builders or sequestrants include acid and/or salt forms (e.g., alkali metal salts) of these compounds. Examples of aminocarboxylates include amino acetates and salts thereof. Suitable amino acetates include: N-hydroxyethylaminodiacetic acid; hydroxyethylenediaminetetraacetic acid; nitrilotriacetic acid (NTA); ethylenediaminetetraacetic acid (EDTA); N-hydroxyethyl-ethylenediaminetriacetic acid (HEDTA); tetrasodium ethylenediaminetetraacetic acid (EDTA); diethylenetriaminepentaacetic acid (DTPA); and alanine-N,N-diacetic acid; n-hydroxyethyliminodiacetic acid; and the like; their alkali metal salts; and mixtures thereof.

Phosphates

Phosphates for use as a builder in the present compositions include any that are suitable for use with the selected nonionic surfactant and penetrant. Suitable phosphates can provide soil dispersion, detergency, water hardness control, and the like to the present composition. Phosphate-containing detergent builders include phosphates such as phosphoric acid and its salts, condensed or polyphosphates and their salts, and aminophosphates and their salts. Suitable condensed or polyphosphates include tripolyphosphates, pyrophosphates, and glassy polymeric meta-phosphates; and their salts, such as alkali metal, ammonium, alkanolammonium, and mixed salts. Examples of such suitable phosphates include sodium or potassium orthophosphate, sodium or potassium pyrophosphate, sodium or potassium tripolyphosphate, sodium hexametaphosphate, and the like. Suitable aminophosphates include nitrilotrismethylene phosphates and other aminophosphates with alkyl or alkaline groups with less than 8 carbon atoms. Such phosphates can assist, to a limited extent, in solidification of the composition by fixing the free water present in the composition as water of hydration.

Polycarboxylates

Polycarboxylates for use as a builder in the present compositions include any that are suitable for use with the nonionic surfactant and penetrant. As used herein, polycarboxylate refers to either or both of the acid and salt forms. Preferred polycarboxylates include iminodisuccinic acids (IDS), sodium polyacrylates, citric acid, gluconic acid, oxalic acid, salts thereof, mixtures thereof, and the like. Additional preferred polycarboxylates include citric or citrate-type chelating agent, polymeric polycarboxylate, acrylic or polyacrylic acid-type stabilizing agents. Preferred polycarboxylates include citric acid or citrate salt (e.g., alkali metal salt).

Additional suitable builders include polyaspartic acid or cocondensates of aspartic acid with other amino acids, C₄-C₂₅-mono- or -dicarboxylic acids and/or C₄-C₂₅-mono- or -diamines. Polyaspartic acids prepared in phosphorus-containing acids and modified with C₆-C₂₂-mono- or -dicarboxylic acids or with C₆-C₂₂-mono- or -diamines are particularly preferably employed.

Polymeric polycarboxylates that can be employed in certain embodiments of the present invention include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

Inorganic Builders

Inorganic builders for use in the present compositions include any that are suitable for use with the nonionic surfactant and penetrant and include silicates, carbonates, sulfates, salts or acid forms thereof, mixtures thereof, and the like. Preferred silicates include zeolites and aluminosilicates, such as sodium aluminosilicate (SAS). Preferred carbonates include alkali metal salts, such as alkali metal carbonates, bicarbonates, and/or sesquicarbonates. Preferably the compositions and methods of the present invention include a builder including an alkali metal carbonate.

Alkalinity Sources

The cleaning composition of or employed in the present invention can include effective amounts of one or more inorganic detergents or alkaline sources to enhance cleaning of a substrate and improve soil removal performance of the composition. A variety of amphoteric surfactants, or mixtures of amphoteric surfactants, can be employed. Suitable amphoteric surfactants are commercially available from a number of sources. Examples of suitable alkalinity sources include alkali metal salts, acidic salts, inorganic alkalinity sources, and the like. Any of a variety of known sources of alkalinity can be used in conjunction with the invention.

Some embodiments of the cleaning composition optionally include salt, or one or more additional salts, for example, alkali metal salt. The alkali metal salt can act as an alkalinity source to enhance cleaning of a substrate, and improve soil removal performance of the composition.

Additionally, in some embodiments the alkali metal salts can provide for the formation of an additional binder complex or binding agent including: alkali metal salt; organic sequestrant including a phosphonate, an aminocarboxylic acid, or mixtures thereof; and water. We refer to such binder complexes as “E-Form” hydrates. Such E-Form hydrates are discussed in detail in U.S. Pat. Nos. 6,177,392; 6,150,324; 6,156,715; and 6,258,765; each of which is incorporated herein by reference. The binding agent can include the organic sequestrant and the active oxygen compound. Preferably the binding agent has melting transition temperature in the range of about 120° C. to 160° C.

Some examples of alkali metal salts include alkali metal carbonates, silicates, phosphates, phosphonates, sulfates, borates, or the like, and mixtures thereof. Alkali metal carbonates are more preferred, and some examples of preferred carbonate salts include alkali metal carbonates such as sodium or potassium carbonate, bicarbonate, sesquicarbonate, mixtures thereof, and the like; preferably sodium carbonate, potassium carbonate, or mixtures thereof.

Additionally or alternatively, salts, for example acidic salts, can be included as pH modifiers, sources of acidity, effervescing aids, or other like uses. Some examples of salts for use in such applications include sodium bisulfate, sodium acetate, sodium carbonate, sodium bicarbonate, citric acid salts, and the like and mixtures thereof. The composition can include up to about 30% by weight such material, usually up to about 20 wt-%. It should be understood that agents other than salts that act as pH modifiers, sources of acidity, effervescing aids, or like, can also be used in conjunction with the invention.

Additional alkalinity sources can include, for example, inorganic alkalinity sources, such as an alkali metal hydroxide or silicate, or the like. Suitable alkali metal hydroxides include, for example, sodium or potassium hydroxide. Examples of useful alkaline metal silicates include sodium or potassium silicate (with a M₂O:SiO₂ ratio of 1:2.4 to 5:1, M representing an alkali metal) or metasilicate. Other sources of alkalinity include a metal borate such as sodium or potassium borate, and the like; ethanolamines and amines; and other like alkaline sources.

The composition can include up to about 30 wt-%, typically up to about 20 wt-%, preferably about 2 to about 10 wt-% of an alkalinity source, salt, most preferably about 2 to about 5 wt-%.

Anionic Hydrotrope

The composition may include an anionic hydrotrope to provide stability to the composition. A variety of anionic hydrotropes, or mixtures of anionic hydrotropes, can be employed. Suitable anionic hydrotropes are commercially available from a number of sources.

Examples of suitable anionic hydrotropes include sulfonates, carboxylates, sulfates and phosphates. Preferred anionic hydrotropes for use in the composition include xylene and cumene sulfonate, and C6-C 12 carboxylates. One preferred hydrotrope is sodium xylene sulfonate. A 40% solution of sodium xylene sulfonate is a preferred ingredient to use.

Any hydrotrope should be present at a level as to inhibit phase separation of the concentrated composition. The composition can include up to about 30 wt-%, typically up to about 20 wt-%, preferably about 2 to about 10 wt-% of an anionic hydrotrope, most preferably about 2 to about 5 wt-%.

Various Other Additives

The cleaning compositions of or employed in the present invention can further include additional functional materials or additives that provide a beneficial property, for example, to aid in dissolution when dispersed in an aqueous solution, e.g., for a particular use. Examples of conventional additives include one or more of each of salt or additional salt, acidity source, pH buffer, hardening agent, debrowning agent, solubility modifier, detergent filler, water softener, defoamer, anti-redeposition agent, precipitation threshold agent or system, antimicrobial agent, aesthetic enhancing agent (i.e., dye, odorant, perfume), optical brightener, bleaching agent, enzyme, effervescent agent, activator for the active oxygen compound, tablet dissolution aid, other such additives or functional ingredients, and the like, and mixtures thereof. Adjuvants and other additive ingredients will vary according to the type of composition being manufactured, and the intended end use of the composition.

Bleaching Agents

The composition can optionally include bleaching agents for lightening or whitening a substrate, including bleaching compounds capable of liberating an active halogen species, such as Cl₂, Br₂, I₂, ClO₂, BrO₂, IO₂, —OCl⁻, —OBr⁻ and/or, —Ol⁻, under conditions typically encountered during the cleansing process. Suitable bleaching agents for use in the present cleaning compositions include, for example, chlorine-containing compounds such as a chlorite, a hypochlorite, chloramine. Preferred halogen-releasing compounds include the alkali metal dichloroisocyanurates, chlorinated trisodium phosphate, the alkali metal hypochlorites, alkali metal chlorites, monochloramine and dichloramine, and the like, and mixtures thereof. Encapsulated chlorine sources can also be used to enhance the stability of the chlorine source in the composition (see, for example, U.S. Pat. Nos. 4,618,914 and 4,830,773, the disclosures of which are incorporated by reference herein). A bleaching agent can also be peroxygen or active oxygen source such as hydrogen peroxide, perborates, for example sodium perborate mono and tetrahydrate, sodium carbonate peroxyhydrate, phosphate peroxyhydrates, and potassium permonosulfate, with and without activators such as tetraacetylethylene diamine, and the like, as discussed above. A cleaning composition can include a minor but effective additional amount of a bleaching agent, preferably about 0.1-10 wt-%, preferably about 1-6 wt-%.

Optical Brighteners

Optical brighteners, also referred to as fluorescent whitening agents or fluorescent brightening agents, can be included to provide optical compensation for the yellow cast in fabric substrates. With optical brighteners, yellowing is replaced by light emitted from optical brighteners present in the area commensurate in scope with yellow color. The violet to blue light supplied by the optical brighteners combines with other light reflected from the location to provide a substantially complete or enhanced bright white appearance. This additional light is produced by the brightener through fluorescence. Optical brighteners absorb light in the ultraviolet range 275 through 400 nm. and emit light in the ultraviolet blue spectrum 400-500 nm.

Optical brighteners useful in the present invention are commercially available. Commercial optical brighteners which can be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles and other miscellaneous agents. Examples of these types of brighteners are disclosed in “The Production and Application of Fluorescent Brightening Agents”, M. Zahradnik, Published by John Wiley & Sons, New York (1982), the disclosure of which is incorporated herein by reference.

Dyes/Odorants

Various dyes, odorants including perfumes, and other aesthetic enhancing agents can also be included in the composition. Dyes can be included to alter the appearance of the composition, as for example, Direct Blue 86 (available from Miles), Fastusol Blue (available from Mobay Chemical Corp.), Acid Orange 7 (available from American Cyanamid), Basic Violet 10 (available from Sandoz), Acid Yellow 23 (available from GAF), Acid Yellow 17 (available from Sigma Chemical), Sap Green (available from Keyston Analine and Chemical), Metanil Yellow (available from Keystone Analine and Chemical), Acid Blue 9 (available from Hilton Davis), Sandolan Blue/Acid Blue 182 (available from Sandoz), Hisol Fast Red (available from Capitol Color and Chemical), Fluorescein (available from Capitol Color and Chemical), Acid Green 25 (available from Ciba-Geigy), and the like.

Fragrances or perfumes that can be included in the compositions include, for example, terpenoids such as citronellol, aldehydes such as amyl cinnamaldehyde, a jasmine such as ClS-jasmine orjasmal, vanillin, and the like.

Water

The compositions of or employed in the methods of the present invention preferably include water as the carrier for the composition. The water can be any form suitable for use in cleaning compositions, such as tap water, softened water, unsoftened water, and deionized water. A preferred water for use in the composition and methods of having the composition is softened water, typically having a less than 20 grain hardness.

Usually, cleaning compositions according to the present invention will contain no more than about 99 wt-% water and typically no more than about 90 wt-%. Usually, cleaning compositions will contain at least 10 wt-% water, typically at least 20 wt-%. One embodiment includes about 30-99 wt-% water, preferably about 50-80 wt-%, and most preferably 55 to about 70 wt-% water. Use compositions of these concentrates generally contain no more than about 99 wt-% water and at least 50 wt-% water.

Processing, Packaging, and Dispensing of the Composition

The composition can be packaged in a variety of type of packages or packaging materials, such as, for example, a simple bottle or jar, a “tear and pour” pouch, or a water-soluble packet. Typically, the composition is provided in a concentrate form, to be diluted to its “use concentration”.

Methods of Cleaning

The present compositions can be used for cleaning carpets, rugs, and other floor coverings, upholstery made from fiber, yam, fabric, or other textiles, drapery or curtains, and the like. The present compositions can also be used for cleaning surfaces such as counters, backsplashes, tables, and other surfaces. The compositions are suitable for cleaning items that can be cleaned by conventional methods or apparatus, provided those methods or apparatus can employ a liquid cleaning composition. Applying the composition can be accomplished or followed by direction of a liquid stream or mist onto the carpet or upholstery, optionally rubbing and/or brushing the carpet or upholstery and, optionally, removing the composition from the carpet or upholstery, e.g., by blotting, rubbing, or vacuuming. Typically, when the composition is applied to the surface to be cleaned, the composition is present as its use composition, which can be formed by diluting the composition to achieve the desired “use concentration” of product.

The compositions of the present invention can be employed with any of a variety of carpet or upholstery cleaning machines. For example, the present use compositions can be applied by a carpet or upholstery cleaning machine that optionally heats the use composition, sprays it onto the carpet or upholstery, optionally brushes the carpet or upholstery, and vacuums up excess liquid. Alternatively, the present use compositions can be applied with a sprayer and rubbed or brushed into the carpet or upholstery with a rotating brush carpet or upholstery cleaning machine and the excess liquid removed by vacuum or blotting. Still further, the use compositions can be applied with a sprayer or damp sponge, manually brushed, rubbed or otherwise agitated, and excess liquid removed by blotting with a sponge or towel.

A sprayer, for applying the composition, can be trigger operated, pump operated, electrically operated, or operated by any source of pressurized gas such as a can or a pressurizer. In certain embodiments that application means forms a foam from the composition. For example, the sprayer nozzle can include a foaming mechanism, such as a screen or other high surface area feature that causes the composition to foam as it passes through.

Advantageously, cleaning action of the present compositions begins as soon as the composition is applied onto the surface. Rubbing and/or brushing are not required for the cleaning process. However, mechanical action is useful to allow the liquid use composition to more quickly penetrate thick carpet or upholstery. Preferably, however, for highly soiled carpet or upholstery or in high traffic areas of carpet the present method for carpet or upholstery cleaning includes applying a the cleaning composition and then rubbing and/or brushing more or less intensively, for example with a sponge, brush, or other mechanical or electrical device, optionally with the aid of water. Typically the time spent rubbing or brushing is between 1 second to a few minutes per square meter. After applying the cleaning composition, and rubbing or brushing (if any), the composition is removed from the carpet or upholstery, preferably by mechanical means including brushing out and/or vacuuming up the excess liquid or dried composition.

The compositions according to the present invention are preferably applied to the surface to be cleaned as a liquid use composition (e.g., an aqueous preparation). In one method, the user makes the liquid use composition by mixing the concentrated composition with a solvent, such as water, or another carrier, to provide a use composition having an effective level of active ingredients so that satisfactory cleaning is obtained.

The composition concentrate can generally be diluted at a ratio of at least 20 parts concentrate with 1 part solvent. The concentrate can also generally be diluted at a ratio of 1 part concentration with no more than 20 parts solvent. In certain embodiments, the composition can be diluted at a ratio of 10:1 to 1:10 parts concentrate: solvent. In other embodiments 8:1 to 1:8. The amount or concentration of the compositions used can depend on the severity of the stain or soil. In the case of stubborn stains, more than one application can be used to ensure complete removal of the stain.

In another method, the user obtains the liquid use composition premixed (i.e., ready-to-use) in a spray bottle.

The composition is particularly useful in that for heavily soil areas it is often not necessary to pre-spot or pre-spray the area before cleaning, resulting in a significant reduction in labor over the present standard practice of pre-spotting stains followed by pre-spraying heavily soiled areas followed by extracting the entire surface. Indeed, the cleaning compositions herein are particularly suitable to remove dinginess from carpet or upholstery that results from a diffuse layer of soil and/or from general wear. Red Kool-Aid is a stain for which the composition is particularly suited.

The area to be treated employing compositions according to the present invention can be any size. For example, the present methods and compositions can be employed for cleaning all or part of a carpet or upholstery, or for removing individual spots.

Removing stains typically includes lightening the stain's color, preferably lightening the stain so that it is not or is only slightly visible to the human eye as well as mechanically removing the lightened soil from the surface. Removing stains can be accomplished by applying a cleaning composition described herein to the stained area using the previously described methods. The amount of destaining is graded visually.

The present invention can be better understood with reference to the following examples. These examples are intended to be representative of specific embodiments of the invention, and are not intended as limiting the scope of the invention.

### EXAMPLES

A cleaning composition according to the present invention was formulated and tested for carpet stain removal.

### Example 1

A concentrated cleaning composition was prepared by mixing ingredients together to achieve to composition depicted in Table 1:

TABLE 2
Exemplary Concentrated Composition

| Ingredient | Generic Ingredient | Wt- % |
|---|---|---|
| Soft water | Water | 68.18 |
| Tetrasodium EDTA, 40% | Builder | 6.7 |
| Sodium carbonate | Alkalinity source | 1.7 |
| Sodium bicarbonate | Alkalinity source | 2.5 |
| C1012 ethoxylate [6 EO] | Nonionic surfactant | 0.13 |
| Pluronic N3 | Penetrant | 0.09 |
| Tergitol 15-S-7 | Nonionic surfactant | 4.6 |
| Sodium xylene sulfonate, 40% | Anionic surfactant | 7.6 |
| cocoamidopropylbetaine | Amphoteric surfactant | 8.5 |

20 grams of this composition was diluted in 100 mL of water to obtain the use composition (depicted in Table 3) which was then used in the carpet cleaning test method, described below.

TABLE 3
Exemplary Use Composition

| Ingredient | Generic Ingredient | Wt- % |
|---|---|---|
| Soft water | Water | 68.18 |
| Tetrasodium EDTA, 40% | Builder | 6.7 |
| Sodium carbonate | Alkalinity source | 1.7 |
| Sodium bicarbonate | Alkalinity source | 2.5 |
| C1012 ethoxylate [6 EO] | Nonionic surfactant | 0.13 |
| Pluronic N3 | Penetrant | 0.09 |
| Tergitol 15-S-7 | Nonionic surfactant | 4.6 |
| Sodium xylene sulfonate, 40% | Anionic surfactant | 7.6 |
| cocoamidopropylbetaine | Amphoteric surfactant | 8.5 |

Carpet Stain Removal Test

Carpet was stained with red Kool-Aid drink by pouring 20 mL of the drink onto the carpet and allowing it to dry and cure for 2-3 days. The stained carpet was treated with the use composition, above, and also a commercial carpet spotter, “Resolve”, which is commercially available from Reckitt & Coleman. Treating included wetting the stained carpet with the composition or spotter, agitating the wetted area, and blotting away liquid with a paper towel. After the treated spots air dried overnight, they were compared for destaining and graded. Slight change in staining intensity that was mostly a color change was graded 1. A moderate reduction in intensity plus a color change was graded 2. Nearly complete reduction in staining with very little stain remaining was graded 3.

Results

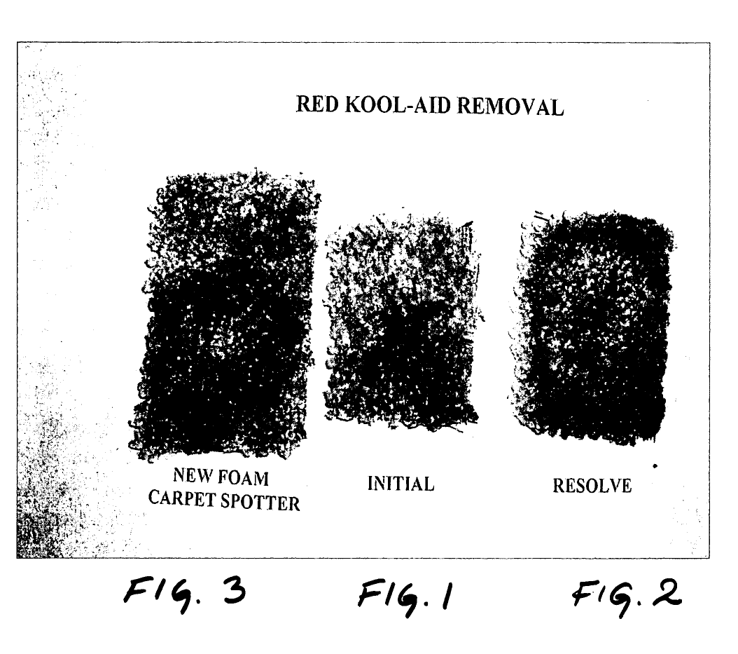

FIG. 1 shows the carpet before cleaning and is notable for the heavy degree of stain and soil. FIG. 2 shows the carpet after cleaning with the commercial detergent. The commercially cleaned carpet still shows numerous stains, for example several at the center of the photograph and one near the white paper towel near top center.

FIG. 3 shows the carpet after cleaning with the inventive composition and method. The carpet is sufficiently clean to show foot prints that have pressed the nap at the top of the photograph. The carpet cleaned by an inventive method and composition shows little or no staining.

### Example 2

A concentrated cleaning composition was prepared by mixing ingredients together to achieve to composition depicted in Table 4:

TABLE 4
Exemplary Concentrated Composition

| Ingredient | Generic Ingredient | Wt- % |
|---|---|---|
| Soft water | Water | 74.35 |
| Tetrasodium EDTA, 40% | Builder | 7.53 |
| Sodium carbonate, low density | Alkalinity source | 1.88 |
| Sodium bicarbonate | Alkalinity source | 2.82 |
| C1012 ethoxylate [6 EO] | Nonionic surfactant | 0.14 |
| Pluronic N3 | Penetrant | 0.09 |
| Sodium xylene sulfonate, 40% | Anionic surfactant | 8.47 |
| cocoamidopropylbetaine | Amphoteric surfactant | 4.71 |

20 grams of this composition was diluted in 100 mL of water to obtain the use composition (depicted in Table 5) depicted below.

TABLE 5
Exemplary Use Composition

| Ingredient | Generic Ingredient | Wt- % |
|---|---|---|
| Soft water | Water | 95.73 |
| Tetrasodium EDTA, 40% | Builder | 1.25 |
| Sodium carbonate, low density | Alkalinity source | 0.31 |
| Sodium bicarbonate | Alkalinity source | 0.47 |
| C1012 ethoxylate [6 EO] | Nonionic surfactant | 0.02 |
| Pluronic N3 | Penetrant | 0.02 |
| Sodium xylene sulfonate, 40% | Anionic surfactant | 1.41 |
| Cocoamidopropylbetaine | Amphoteric surfactant | 0.78 |

It should be noted that, as used in this specification and the appended claims, the singular forms “a,” “an” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

The invention has been described with reference to various specific and preferred embodiments and techniques. However, it should be understood that many variations and modifications may be made while remaining within the spirit and scope of the invention.

1. A cleaning composition comprising:
about 0.01 to about 10 wt-% penetrant; and
about 0.01 to about 20 wt-% nonionic surfactant.

2. The composition of claim 1 wherein the penetrant comprises EO/PO copolymer.

3. The composition of claim 2 further comprising about 1 to about 20 wt-% amphoteric surfactant.

4. The composition of claim 3, comprising:
about 0.02 to about 5 wt-% EO/PO copolymer;
about 0.1 to about 10 wt-% nonionic surfactant; and
about 2 to about 10 wt-% amphoteric surfactant.

5. The composition of claim 3 comprising:
about 0.02 to about 5 wt-% EO/PO copolymer;
about 0.1 to about 10 wt-% nonionic surfactant;
about 2 to about 10 wt-% amphoteric surfactant;
about 2 to about 10 wt-% builder;
about 2 to about 10 wt-% alkalinity source; and
about 2 to about 10 wt-% anionic hydrotrope.

6. The composition of claim 5 wherein the builder comprises aminocarboxylate.

7. The composition of claim 6, wherein the builder comprises polycarboxylic acid and aminocarboxylate.

8. The composition of claim 6, wherein the aminocarboxylate comprises ethylenediaminetetraacetic acid (EDTA), salt thereof, or mixture thereof.

9. The composition of claim 1 wherein the nonionic surfactant comprises one of alkyl-, aryl-, and aralkyl-, alkoxylates, alkylpolyglycosides and their derivatives, amines and their derivatives, and amides and their derivatives.

10. The composition of claim 9 wherein the nonionic surfactant comprises ethoxylate.

11. The composition of claim 9 wherein the ethoxylate comprises C6-C 12 ethoxylate.

12. The composition of claim 3 wherein the amphoteric surfactant comprises betaine.

13. The composition of claim 12 wherein the amphoteric surfactant comprises cocoamidopropylbetaine.

14. A method of cleaning a surface, comprising:
applying to the surface an aqueous cleaning composition comprising:
(a) about 0.02 to about 5 wt-% EO/PO copolymer;
(b) about 0.1 to about 10 wt-% nonionic surfactant; and
(c) about 2 to about 10 wt-% amphoteric surfactant.

15. The method of claim 14, wherein applying comprises brushing or rubbing the cleaning composition on the surface.

16. The method of 14, wherein applying to the surface an aqueous cleaning composition comprises applying to a carpet or upholstery an aqueous cleaning composition.

17. The method of claim 14, further comprising removing a portion of the composition from the surface.

18. The method of claim 14, wherein the cleaning composition comprises:
about 0.02 to about 5 wt-% EO/PO copolymer;
about 0.1 to about 10 wt-% nonionic surfactant;
about 2 to about 10 wt-% amphoteric surfactant;
about 2 to about 10 wt-% builder;
about 2 to about 10 wt-% alkalinity source; and
about 2 to about 10 wt-% anionic hydrotrope.

19. The method of claim 14, wherein the builder comprises aminocarboxylate.

20. The method of claim 19, wherein the aminocarboxylate comprises ethylenediaminetetraacetic acid (EDTA), salt thereof, or mixture thereof.
